(19) United States
(12) Patent Application Publication
(10) Pub. No.: US 2020/0356837 A1
(43) Pub. Date: Nov. 12, 2020

(54) FAST DEEP LEARNING FULLY-CONNECTED INFERENCE

(71) Applicant: Apple Inc., Cupertino, CA (US)

(72) Inventors: Asaf HARGIL, Binyamina (IL); Ali SAZEGARI, Cupertino, CA (US)

(21) Appl. No.: 16/568,177

(22) Filed: Sep. 11, 2019

Related U.S. Application Data
(60) Provisional application No. 62/844,725, filed on May 7, 2019.

(51) Int. Cl. G06N 3/04; G06F 17/16; G06N 3/08; G06N 5/04

(52) U.S. Cl. CPC G06N 3/04; G06N 5/04; G06N 3/08; G06F 17/16

(57) ABSTRACT

This application relates to performing fully-connected inferences using a convolutional neural network. A method includes receiving a two-dimensional input matrix that includes a plurality of elements. The method further includes identifying a two-dimensional weight matrix corresponding to the two-dimensional input matrix, where the two-dimensional weight matrix includes a plurality of weight values. The method further includes transposing a first column of the two-dimensional weight matrix and storing the transposed first column of the two-dimensional weight matrix in a first register having a first length corresponding to the transposed first column. The method further includes generating a first output element by performing a first dot product operation using a first row of the two-dimensional input matrix and the transposed first column. Finally, the method includes storing the first output element in a first row of a two-dimensional output matrix.

### CROSS-REFERENCE TO RELATED APPLICATIONS

The present application claims the benefit of U.S. Provisional Application No. 62/844,725, entitled “FAST DEEP LEARNING FULLY-CONNECTED INFERENCE,” filed May 7, 2019, the content of which is incorporated herein by reference in its entirety for all purposes.

### FIELD

The described embodiments relate generally to algorithms for data processing. More particularly, the present embodiments relate to algorithms for implementing fast deep learning using a column-major ordered fully-connected layer.

### BACKGROUND

A convolution neural network is a class of deep learning networks that typically includes one or more processors, such as one or more vector processors. Convolutional neural networks include various layers that, using the one or more processors, process inputs (e.g., images or other suitable input) and generate outputs (e.g., class scores, image classifications, or other suitable outputs). For example, the convolution neural network can include convolution layers that process sets of inputs with convolution kernels to generate sets of outputs. Convolutional layers are typically configured to detect high level features of the inputs, such as edged, curves, simple colors, and the like.

The output of the convolutional layers may be provided by the one or more processors to a fully-connected layer. The fully-connected layer typically connects every neuron in one layer of the convolutional neural network to every other neuron in another layer of the convolutional neural network. The fully-connected layer is configured to receive inputs from the convolutional layers and generate outputs that can be used to predict classifications for images associated with the inputs. For example, during training of the convolutional neural network, a plurality of images may be provided to the convolutional neural network (e.g., using the convolutional layers, as described). The convolutional neural network may learn by using the fully-connected layer to classify each of the images.

Typically, the fully-connected layer receives a two-dimensional input matrix (e.g., from the convolutional layers) arranged in row-major order. The fully-connected layer (e.g., using the one or more processors) uses a two-dimensional weight matrix that comprises a plurality of weight values to classify the input. For example, to compute a single output element, one or more processors may perform a dot product operation between a row of the two-dimensional input matrix and a row of the two-dimensional weight matrix. The result of all of the dot product operations is a two-dimensional output matrix that comprises a set of values that indicate a probability that an associated input image is an image of a particular object. The accuracy of the output of the fully-connected layer may be determined and the convolutional neural network may be provided inputs until the accuracy of the fully-connected layer output is above a threshold.

As described, the two-dimensional input matrix may be arranged in row-major order. Depending on a variety of factors, the two-dimensional weight matrix may be arranged in row-major order or column-major order. Performing dot product operations using a two-dimensional input matrix arranged in row-major order and a two-dimensional weight matrix arranged in column-major order, can be inefficient as the one or more processors performing the dot product operation does not perform consecutive weight matrix memory read operations to retrieve respective input elements and weight values, which may significantly slow training of the convolutional neural network and/or use of the convolutional neural network by other system.

### SUMMARY

Representative embodiments set forth herein disclose techniques for implementing fast deep learning using a column-major ordered fully-connected layer.

An aspect of the disclosed embodiments is a method for establishing a fully-connected inference implementation using a convolutional neural network. The method includes receiving a two-dimensional input matrix that includes a plurality of elements. The method further includes identifying, by a processor, a two-dimensional weight matrix corresponding to the two-dimensional input matrix, the two-dimensional weight matrix including a plurality of weight values. The method further includes transposing a first column of the two-dimensional weight matrix. The method further includes storing the transposed first column of the two-dimensional weight matrix in a first register having a first length corresponding to the transposed first column. The method further includes generating a first output element by performing a dot product operation using a first row of the two-dimensional input matrix and the transposed first column. The method further includes storing the first output element in a first row of a two-dimensional output matrix.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a two-dimensional input matrix arranged in row-major order and a two-dimensional weight matrix arranged in row-major order, in accordance with some embodiments.

FIG. 2 generally illustrates a two-dimensional input matrix arranged in row-major order and a two-dimensional weight matrix arranged in column-major order, in accordance with some embodiments.

FIG. 3 generally illustrates a multi-layer convolution operation for filtering two-dimensional input images, in accordance with some embodiments.

FIG. 4 generally illustrates a vector processor, in accordance with some embodiments.

FIG. 5 generally illustrates the vector processing unit, in accordance with some embodiments.

FIG. 6 generally illustrates a technique for efficiently performing a matrix multiplication of a two-dimensional input matrix arranged in row-major order and a two-dimensional weight matrix arranged in column-major order, in accordance with some embodiments.

FIG. 7 illustrates a workflow for compiling source code into an executable program, in accordance with some embodiments.

FIG. 8 illustrates a flowchart of a method for optimizing a convolution operation on a vector processor, in accordance with some embodiments.

FIG. 9 generally illustrates a detailed view of an exemplary computing device that can be used to implement the various apparatus and/or methods described herein, in accordance with some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

As described, a convolution neural network is a class of deep learning networks that typically includes one or more processors, such as one or more vector processors. Convolutional neural networks include various layers that, using the one or more processors, process inputs (e.g., images or other suitable input) and generate outputs (e.g., class scores, image classifications, or other suitable output). For example, the convolution neural network can include convolution layers that process sets of inputs with convolution kernels to generate sets of outputs. Convolutional layers are typically configured to detect high level features of the inputs, such as edged, curves, simple colors, and the like.

The output of the convolutional layers may be provided by the one or more processors to a fully-connected layer. The fully-connected layer typically connects every neuron in one layer of the convolutional neural network to every other neuron in another layer of the convolutional neural network. The fully-connected layer is configured to receive inputs from the convolutional layers and generate outputs that can be used to predict classifications for images associated with the inputs. For example, during training of the convolutional neural network, a plurality of images may be provided to the convolutional neural network (e.g., using the convolutional layers, as described). The convolutional neural network may learn by using the fully-connected layer to classify each of the images. Additionally, or alternatively, once the convolutional neural network is trained, the convolutional neural network may be used to infer and/or predict contents of the input images.

Typically, the fully-connected layer receives a two-dimensional input matrix (e.g., from the convolutional layers) arranged in row-major order. The fully-connected layer (e.g., using the one or more processors) uses a two-dimensional weight matrix that comprises a plurality of weight values to classify the input. For example, the one or more processors may perform a matrix multiplication operation (e.g. a dot product operation) using the two-dimensional input matrix and the two-dimensional weight matrix. The result of the matrix multiplication operation is a two-dimensional output matrix that comprises probability values that indicate a probability that an associated input image is an image of a particular object. The accuracy of the output of the fully-connected layer may be determined and the convolutional neural network may be provided inputs until the accuracy of the fully-connected layer output is above a threshold.

As described, the two-dimensional input matrix is typically arranged in row-major order, such that, a row in the two-dimensional input matrix includes a plurality of associated elements. For example, a first row of elements may be associated with a first batch, and second row of elements may be associated with a second batch, and so on. Depending on a variety of factors, the two-dimensional weight matrix may be arranged in row-major order or column-major order. For example, a hardware structure of memory used in a computing device and/or computing devices on which the convolutional neural network resides and/or which the convolutional neural network uses to process inputs and generate outputs, may dictate whether the two-dimensional weight matrix is arranged in row-major order or column-major order. Additionally, or alternatively, a programming language and/or programming technique associated with the convolutional neural network may dictate whether the two-dimensional weight matrix is arranged in row-major order or column-major order.

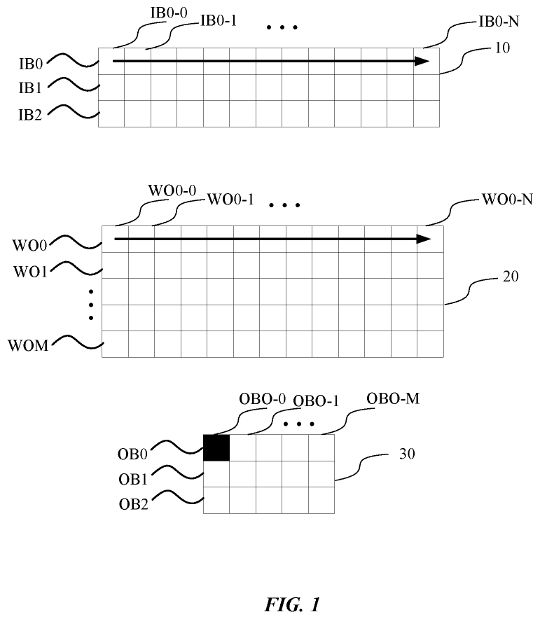

FIG. 1 generally illustrates a two-dimensional input matrix 10 arranged in row-major order and a two-dimensional weight matrix 20 arranged in row-major order, in accordance with some embodiments. The two-dimensional input matrix 10 may include a plurality of input batches, such as batch IB0, batch IB1, and batch IB2. While only three batches are illustrated, it should be understood the two-dimensional input matrix may include any suitable number of batches. Each batch includes a plurality of elements arranged in a corresponding row of the two-dimensional input matrix 10. For example, batch IB0 includes elements IB0-0 to IB0-N. As described, the elements of the two-dimensional input matrix correspond to output elements from a previous layer in the convolutional neural network. For example, the previous layer may include a convolutional layer and the output may include a two-dimensional output matrix (e.g., sometimes referred to as an activation map of high level features detected for the image received by the convolutional neural network).

The two-dimensional weight matrix includes a plurality weight values. The weight values, when applied to the input elements, as will be described, indicate a probability that a batch of elements below to a particular class. For example, a processor, as will be described, performs a series of dot product operations using the two-dimensional input matrix 10 and the two-dimensional weight matrix 20 to generate a two-dimensional output matrix, such as a two-dimensional output matrix 30 that includes a plurality of probability values. A first row OB0 of the two-dimensional output matrix 30 includes probability values that the elements of batch IB0 of the two-dimensional input matrix 10 bellows to particular classes. For example, a first probability value OB0-0 of row OB0 of the two-dimensional output matrix 30 may indicate a probability that the elements associated with batch IB0 of the two-dimensional input matrix 10 belongs to a first class. Each other probability value of the first row OB0 of the two-dimensional output matrix 30 indicates other probabilities that the elements of batch IB0 of the two-dimensional input matrix 10 belongs to other classes.

During training of the convolutional neural network, the weight values may be randomized, which may lead to incorrect probability values (e.g., incorrect classification of input images). As the convolutional neural network learns (e.g., through backpropagation), the weight values are adjusted, which may improve the accuracy of the probability values. This weight adjustment may continue until the accuracy of the probability values is above a threshold (e.g., the convolutional neural network is sufficiently trained to be used by other systems to infer and/or predict contents of input images).

To perform the matrix multiplication operation of the two-dimensional input matrix 10 (e.g., arranged in row-major order) and the two-dimensional weight matrix 20 (e.g., arranged in column-major order), the processor determines a product between of each element in a row of the two-dimensional input matrix 10 and a corresponding weight value in a row of the two-dimensional weight matrix 20. The processor them sums the products to generate an output probability. The output probability is then stored in the two-dimensional output matrix 30. For example, the processor determines a product between the element IB0-0 in batch IB0 (e.g., the first row) of the two-dimensional input matrix 10 and the weight value WO0-0 in row WO0 of the two-dimensional weight matrix 20.

The processor continues to determine products between elements IB0-1 through IB0-N of batch IB0 of the two-dimensional input matrix 10 and weight values WO0-1 through WO0-N of row WO0 of the two-dimensional weight matrix 20. The processor sums the determined products and stores the result as probability OB0-0 in row OB0 of the two-dimensional output matrix 30. The processor then determines products between elements in batch IB0 of the two-dimensional input matrix 10 and weight values in row WO1 of the two-dimensional weight matrix 20 and stores the result of the sum of the determined products as probability OB0-1 of row OB0 of the two-dimensional output matrix 30. The processor continues for to determine products between elements in batch IB0 of the two-dimensional input matrix and each weight value of each row of the two-dimensional weight matrix 20 (e.g., through row WOM of the two-dimensional weight matrix 20) to generate probabilities for row OB0 of the two-dimensional output matrix 30 through probability OB0-M.

The processor then determines products between elements of batch IB1 (e.g., the second row) and batch IB2 (e.g., the third row) of the two-dimensional input matrix 10 and corresponding weight values in each of the rows of the two-dimensional weight matrix 20 to generate probability values stored in row OB1 and row OB2 of the two-dimensional output matrix 30, respectively. As is illustrated, the two-dimensional output matrix 30 includes a number of rows corresponding to a number of rows of the two-dimensional input matrix 10 and a number of columns corresponding to a number of rows of the two-dimensional weight matrix 20.

Typically, performing a series of dot product operations using a two-dimensional input matrix arranged in row-major order and a two-dimensional weight matrix arranged in row-major order, is relatively efficient as the processor can perform consecutive memory read operations to retrieve respective input elements and weight values. However, performing a matrix multiplication operation using a two-dimensional input matrix arranged in row-major order and a two-dimensional weight matrix arranged in row-major order requires performing horizontal sums, which, as the size of the two-dimensional input matrix increases (e.g., in the case where the convolutional neural network is used to perform fully-connected inference), may increase the amount of time it takes to perform the matrix multiplication operation.

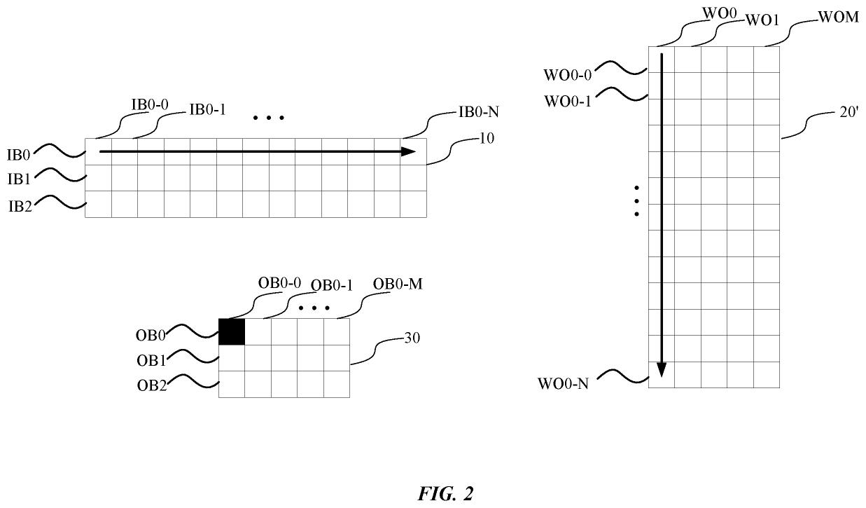

FIG. 2 generally illustrates the two-dimensional input matrix 10 arranged in row-major order and a two-dimensional weight matrix 20′ arranged in column-major order, in accordance with some embodiments.

As described, the processor performs a matrix multiplication operation (e.g., dot product operation) using the two-dimensional input matrix 10 and the two-dimensional weight matrix 20′ in order to generate the two-dimensional output matrix 30. The processor determines a product between of each element in a row of the two-dimensional input matrix 10 and a corresponding weight value in a column of the two-dimensional weight matrix 20′. The processor them sums the products to generate an output probability. For example, the processor determines a product between the element IB0-0 in batch IB0 (e.g., the first row) of the two-dimensional input matrix 10 and the weight value WO0-0 in column WO0 of the two-dimensional weight matrix 20′.

The processor continues to determine products between elements IB0-1 through IB0-N of batch IB0 of the two-dimensional input matrix 10 and weight values WO0-1 through WO0-N of column WO0 of the two-dimensional weight matrix 20′. The processor sums the determined products and stores the result as probability OB0-0 in row OB0 of the two-dimensional output matrix 30. The processor then determines products between elements in batch IB0 of the two-dimensional input matrix 10 and weight values in column WO1 of the two-dimensional weight matrix 20′ and stores the result of the sum of the determined products as probability OB0-1 of row OB0 of the two-dimensional output matrix 30. The processor continues for to determine products between elements in batch IB0 of the two-dimensional input matrix and each weight value of each column of the two-dimensional weight matrix 20′ (e.g., through column WOM of the two-dimensional weight matrix 20′) to generate probabilities for row OB0 of the two-dimensional output matrix 30 through probability OB0-M.

The processor then determines products between elements of batch IB1 (e.g., the second row) and batch IB2 (e.g., the third row) of the two-dimensional input matrix 10 and corresponding weight values in each of the columns of the two-dimensional weight matrix 20′ to generate probability values stored in row OB1 and row OB2 of the two-dimensional output matrix 30, respectively. As is illustrated, the two-dimensional output matrix 30 includes a number of rows corresponding to a number of rows of the two-dimensional input matrix 10 and a number of columns corresponding to a number of columns of the two-dimensional weight matrix 20′.

Typically, performing a matrix multiplication operation using a two-dimensional input matrix arranged in row-major order and a two-dimensional weight matrix arranged in column-major order, can be inefficient as the processor does not perform consecutive memory read operations to retrieve respective input elements and weight values, which may significantly slow training of the convolutional neural network and/or use of the convolutional neural network by other system. Typically, in order to improve efficiency of the matrix multiplication operation, the processor may first transpose the two-dimensional weight matrix 20′, such that, the two-dimensional weight matrix 20′ is converted from being arranged in column-major order to being arranged in row-major order. The processor then performs the matrix multiplication operation between the two-dimensional input matrix 10 and the transposed version of the two-dimensional weight matrix 20′ (e.g., arranged in row-major order).

However, such transposition of the two-dimensional weight matrix 20′ can also be relatively resource intensive, and as convolutional neural network training moves from server farms to end user devices (e.g., such as laptop computers, desktop computers, tablet computing devices, and mobile computing devices, such as smart phones), such transposition of the two-dimensional weight matrix 20′ may not be an efficient solution. According, systems and methods, such as those described herein, that increases the efficiency of a matrix multiplication operation between a two-dimensional input matrix arranged in row-major order and a two-dimensional weight matrix arranged in column-major order, may be desirable.

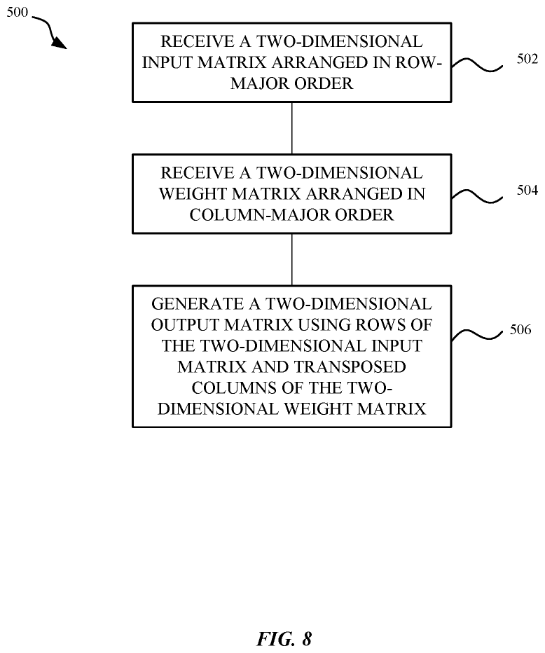

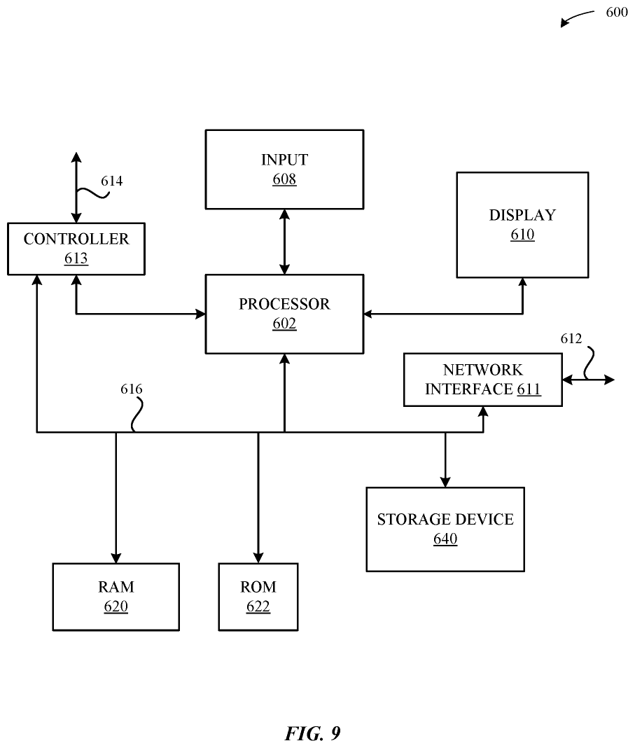

These and other embodiments are discussed below with reference to FIGS. 1-9; however, those skilled in the art will readily appreciate that the detailed description given herein with respect to these figures is for explanatory purposes only and should not be construed as limiting.

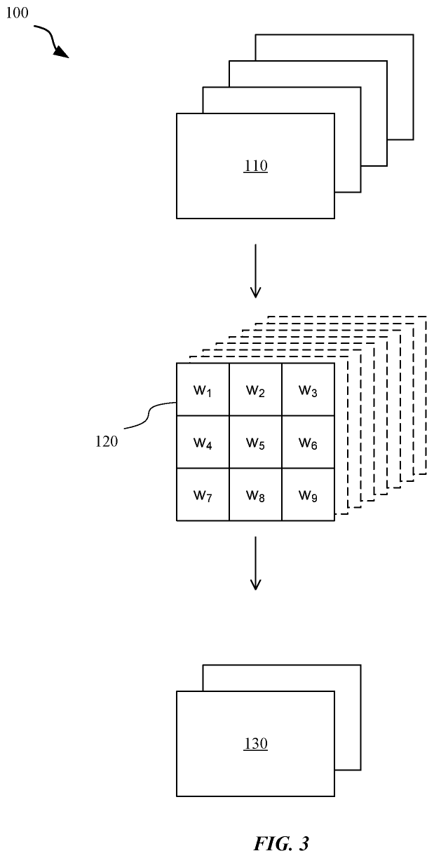

FIG. 3 generally illustrates a multi-layer convolution operation 100 for filtering two-dimensional input images, in accordance with some embodiments. As depicted in FIG. 3, a number of two-dimensional images 110 are received as input to the convolution operation 100. Each image 110 comprises a two-dimensional array of scalar values. Each scalar value in the two-dimensional array can be referred to as an element or, alternatively, a pixel. In some embodiments, each element is a single-precision floating-point value comprising 32-bits. In other embodiments, each element can be represented using another format, such as double-precision floating-point, fixed-point, or integer formats.

Each layer of the multi-layer input can be referred to as a channel of the multi-layer input. In other words, each channel is a separate and distinct image in a set of images provided as the input to the convolution operation 100. In some embodiments, each channel can be a separate color channel of a single color image (e.g., red, green, blue, and alpha channels). In other embodiments, each channel can be a separate and distinct image, each image being unrelated to the other images in the set of images. Such embodiments are particularly suited to deep learning, where a convolution neural network (CNN) can be configured to process a large number of images to produce a result. For example, in a typical implementation of a CNN, the input to the CNN can include 512 separate and distinct images provided as different channels of the input.

The convolution operation 100 generates a number of two-dimensional images 130 as an output of the convolution operation 100. The number of output images 130 may not match the number of input images 110. In other words, the number of channels in the multi-layer output may not be equal to the number of channels in the multi-layer input. However, in some embodiments, the number of channels in the multi-layer output matches the number of channels of the multi-layer input.

Each channel of the output (e.g., each output image 130) is associated with a set of coefficients corresponding to each channel of the input (e.g., each input image 110). Each image 110 is processed by a corresponding convolution kernel 120, which is defined as a set of coefficients applied to a portion of the image 110 to generate a portion of an element of an output of the convolution operation. The intermediate values generated by processing each input image 110 with a corresponding convolution kernel 120 are then summed to produce the element for a particular output image 130. Each output image 130 can be associated with a set of convolution kernels 120, where a number of convolution kernels 120 associated with the output image 130 matches the number of input images 110. For example, as depicted in FIG. 3, each of two output images 130 is associated with four convolution kernels 120 corresponding to the four input images 110, for a total of eight sets of coefficients utilized by the convolution operation 100.

The convolution kernels 120 can be one-dimensional or two-dimensional. Each convolution kernel 120 can be as small as size 1×1, containing only one coefficient. In the one-dimensional case, the convolution kernel 120 can be of size d×1 or 1×d as applied to the rows or columns, respectively, of the image 110. In the two-dimensional case, the convolution kernel 120 can be of size d_{row}×d_{col} as applied to a two-dimensional window of the image 110. For example, common sizes of two-dimensional convolution kernels are 3×3 or 5×5, which include nine or twenty five coefficients, respectively.

As described, the output of the convolutional layers of the CNN (e.g., resulting from the convolutional operation 100 other convolutional operations performed on subsequent layers of the CNN) is provided to the fully-connected layer of the CNN. At the fully-connected layer of the CNN, a matrix multiplication operation is performed using a two-dimensional input matrix arranged in row-major order and a two-dimensional weight matrix arranged in column-major order to generate a two-dimensional output matrix that includes a plurality of probability values indicating probabilities that the elements of the images received from the convolutional operation 100 are particular classes of images.

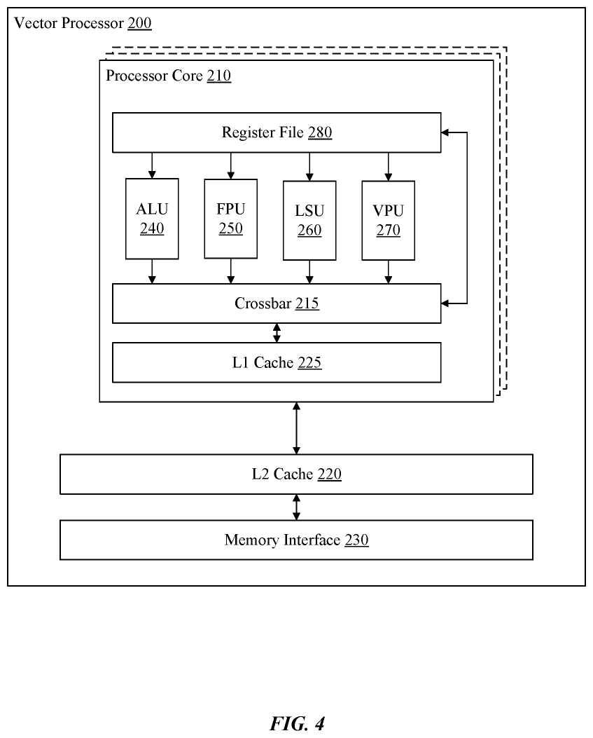

FIG. 4 illustrates a vector processor 200, in accordance with some embodiments. The matrix multiplication operation can be implemented on the vector processor 200. In some embodiments, a software library is provided for implementing the matrix multiplication operation on the vector processor 200. The software library can include a set of instructions to process matrix multiplication operations, such as dot product operations, using various two-dimensional input matrices and various two-dimensional weight matrices. Additionally, or alternatively, the software library may include a set of instructions indicating which two-dimensional weight matrix corresponds to a particular two-dimensional input matrix, which weight values correspond to a particular input image, or a combination thereof

The vector processor 200 includes one or more processor cores 210. Each processor core 210 maintains architectural state including a number of registers in a register file 280, program counters, interrupt mask registers, instruction flag registers, and/or pipeline registers. The architectural state can be referred to as a processor context. The specific data included in the architectural state can vary depending on the implementation of the processor.

In some embodiments, a processor core 210 can maintain multiple sets of architectural state per processor core 210 to implement simultaneous multi-threading (SMT). For example, a processor core 210 can maintain two program counter registers, two sets of operand registers, two sets of interrupt mask registers, and so forth to implement SMT for two threads. SMT enables the processor core 210 to switch between two or more threads without having to switch the processor context by storing the architectural state for the active thread to a memory and loading architectural state for a different thread from the memory.

As depicted in FIG. 4, the vector processor 200 includes a multi-level memory hierarchy including a level 1 (L1) cache 225 in each processor core 210 and a level 2 (L2) cache 220 shared by multiple processor cores 210. The L2 cache 220 is coupled to a memory interface 230 that is attached to pads of the integrated circuit of the vector processor 200, which are coupled to an external memory device such as a dynamic random access memory (DRAM). Although not shown explicitly, the L1 cache 225 can be divided into an instruction cache and a data cache storing instructions and data, respectively. Additional units of the processor core 210, such as a fetch unit, decode unit, branch prediction unit, and the like, can load instructions for a thread into the instruction cache such that an instruction is ready to be executed when the program counter points to an address for the instruction.

After an instruction has been decoded, control logic for the processor core 210 configures one or more functional units of the processor core 210 to execute the instruction. In some embodiments, the processor core 210 includes an arithmetic logic unit (ALU) 240, a floating-point unit (FPU) 250, a load/store unit (LSU) 260, and a vector processing unit (VPU) 270. The ALU 240 is configured to execute instructions to perform arithmetic operations such as addition, subtraction, multiplication, and division utilizing integer operands. The FPU 250 is configured to execute instructions to perform arithmetic operations such as addition, subtraction, multiplication, and division utilizing floating-point operands. The ALU 240 and FPU 250 operate on scalar values of, typically, 32 or 64 bits. The LSU 260 is configured to execute instructions to load values from external memory into the register file 280 and/or store values from the register file 280 to the external memory. The LSU 260 interacts with the external memory indirectly via the L1 cache 225. The VPU 270 is configured to execute instructions to perform arithmetic operations such as addition, subtraction, multiplication, and division utilizing vector operands. The VPU 270 provides the vector processor 200 with the ability to execute single instruction multiple data (SIMD) instructions.

In some embodiments, the register file 280 includes registers sized to store vector operands. A vector operand refers to an operand having a number of bits that is an integer multiple of a bit width of the data paths implemented by the VPU 270. For example, the VPU 270 can be implemented to include four parallel data paths, configured to operate on single-precision floating-point operands (e.g., 32-bits). A register for a vector operand for such an implementation of the VPU 270 can be sized to hold, e.g., 128 bits, which can store four separate elements of data (e.g., single-precision floating-point values) for the four parallel data paths. Consequently, a single vector instruction can be executed by the VPU 270, which loads vector operands containing four elements from the register file 280 and generates four single-precision values stored in a 128-bit accumulator register in parallel. It will be appreciated that although the VPU 270 has been described as using 128-bit registers containing four elements, other embodiments of the VPU 270 can utilize 256-bit registers containing eight elements, 512-bit registers containing 16 elements, 256-bit registers containing four double-precision floating-point elements, 512-bit registers containing eight double-precision floating-point elements, 128-bit registers containing eight half-precision floating-point elements, and so forth. The number of parallel data paths implemented within the VPU 270 should equal the number of elements stored in the registers for the vector operands.

In some embodiments, the outputs of the functional units are connected to a crossbar 215 or other type of switchable interconnect used to route signals between the functional units, the register file 280, and/or the L1 cache 225. For example, the crossbar 215 can be configured to connect the output of a functional unit, such as the FPU 250 or the VPU 270 to a write port of the register file 280 such that a result generated by the functional unit is written to a particular register, which can then be utilized as an operand for a subsequent instruction executed by the functional unit. As another example, the LSU 260 can provide a value from a register in the register file 280 to the L1 cache 225 to write the value to the external memory.

It will be appreciated that the architecture of the vector processor 200 depicted in FIG. 4 is merely one example of a vector processor 200 and other architectures are contemplated as being within the scope of the present disclosure. For example, each processor core 210 can include two or more VPUs 270 in addition to the other functional units such that multiple vector operations can be performed in parallel. Other components of the processor 200 have been omitted for clarity. For example, clock generation and distribution circuits, scheduling logic, and various buses or interconnects have been omitted to avoid obscuring the description of the embodiments.

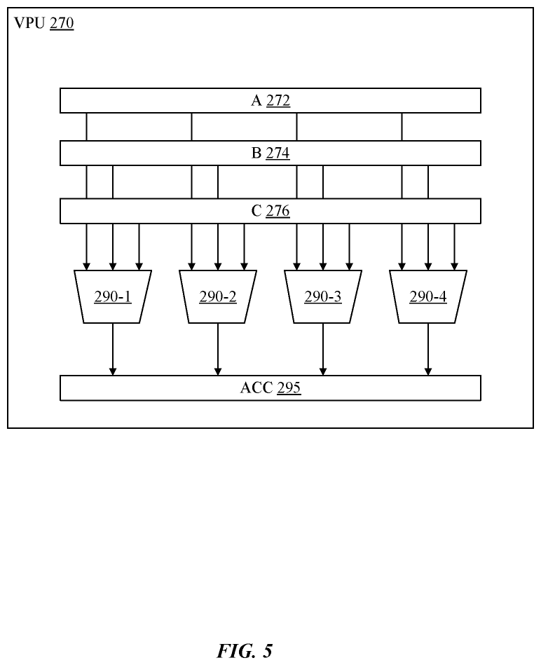

FIG. 5 illustrates the VPU 270, in accordance with some embodiments. The VPU 270 includes a number of data paths 290 operating in parallel. The data paths 290 share access to vector operands stored in special registers in the VPU 270. In some embodiments, the data paths 290 are floating-point data paths configured to execute FMA instructions that have three input operands and one output operand. The input operands are stored in input collectors A 272, B 274, and C 276. Input operands are read from the register file 280 and latched in the corresponding input collector until the instruction is ready to be executed. The vector output, combining the output elements of the data paths 290, is stored in an accumulator 295.

In some embodiments, an FMA instruction causes each data path 290 to read a first element from the input collector A 272 and read a second element from the input collector B 274. The first element is multiplied by the second element to generate a product, which is then added to a third element read from the input collector C 276. The result of the addition of the product and the third element is stored in the accumulator 295. In some embodiments, the VPU 270 can be configured to write the result stored in the accumulator register 295 into the input collector C 276 such that the result can be added to a new product calculated using new operand(s) loaded into at least one of the input collector A 272 or input collector B 274 during a subsequent FMA instruction.

Again, in other embodiments, the VPU 270 can include a different number of data paths 290 operating in parallel and sharing elements from vector operands stored in the input collectors. In yet other embodiments, the data paths 290 can be configured to operate on 16-bit, 64-bit, or 128-bit elements rather than 32-bit elements. In still other embodiments, the VPU 270 can include, in addition to or in lieu of data paths 290, additional data paths, and registers configured to operate on integer elements rather than floating-point elements. In some embodiments, the vector processor 200 includes the VPU 270 in lieu of the ALU 240 and the FPU 250.

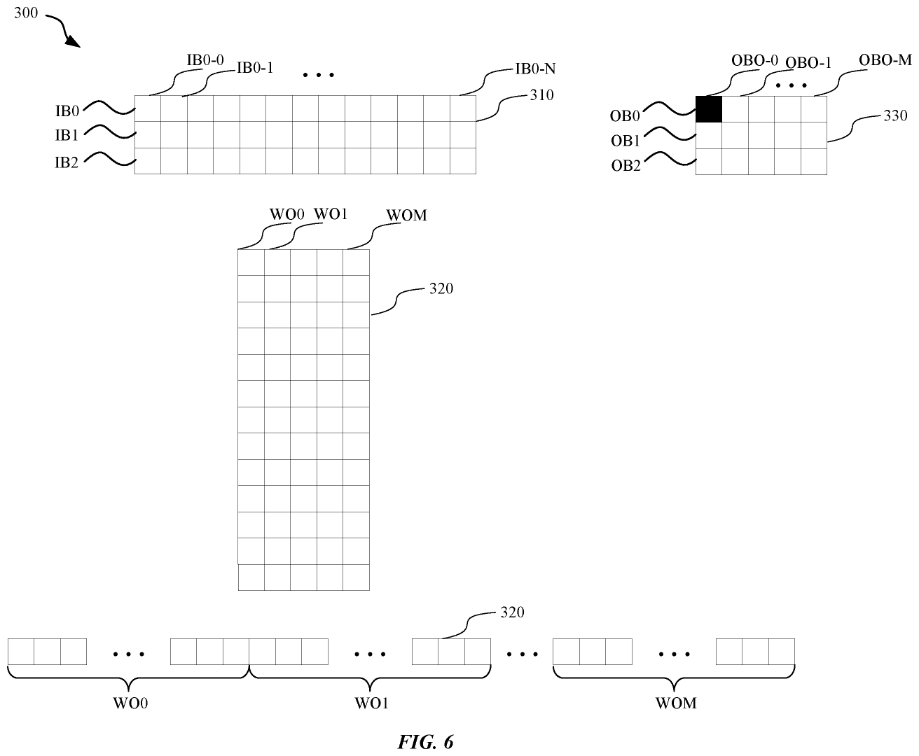

FIG. 6 generally illustrates a technique 300 for efficiently performing a matrix multiplication operation of a two-dimensional input matrix 310 arranged in row-major order and a two-dimensional weight matrix 320 arranged in column-major order, in accordance with some embodiments. As described, the VPU 270 may be configured to perform a series of dot product operations in order to generate a two-dimensional output matrix 330. In some embodiments, the matrix manipulation operation of the two-dimensional input matrix 310 arranged in row-major order and the two-dimensional weight matrix 320 arranged in column-major order can be vectorized. In some embodiments, the two-dimensional input matrix 310 includes a first batch of elements IB0, a second batch of elements IB1, and a third batch of elements IB2. As descried, the two-dimensional input matrix 310 may include any suitable number of batches. The two-dimensional output matrix 330 includes a first batch of output elements (e.g. probabilities) OB0, a second batch of output elements OB1, and a third batch of output elements OB2.

The two-dimensional weight matrix 320 includes columns WO0 through column WOM. In some embodiments, the VPU 270 is configured to transpose each column WO0 thought WOM of the two-dimensional weight matrix 320. Additionally, or alternatively, the VPU 270 may store the transposed columns WO0 through WOM of the two-dimensional weight matrix 320 in place (e.g., in the same storage location) and may reuse the transposed columns WO0 through WOM, for example, when the CNN is used to infer and/or predict the contents of input images. Accordingly, the VPU 270 may omit transposing the columns WO0 through WOM, as the columns WO0 through WOM may be previously transposed and stored.

In some embodiments, the VPU 270 transposes the column WO0 of the two-dimensional weight matrix 320. The VPU 270 stores, in sequential order, the weight values corresponding to the transposed column WO0 in a register having a length corresponding to the number of weight values of the transposed column WO0. For example, the register may a length N, which corresponds to the number of rows in the two-dimensional weight matrix 320. It should be understood that while only limited examples are described herein, the two-dimensional weight matrix 320 can have any number of rows. Additionally, or alternatively, the registers can have any suitable length. The VPU 270 may then transpose the column WO1 of the two-dimensional weight matrix 320. The VPU 270 may then store, in sequential order, following the transposed column WO0, the weight values corresponding to the transposed column WO1 in a register. The VPU 270 continues to transpose the columns of the two-dimensional weight matrix 320 through column WOM. The VPU 270 then stores, sequentially, the weight values corresponding to each transposed column of the two-dimensional weight matrix 320 through column WOM in sequential registers.

The VPU 270 is configured to generate the two-dimensional output matrix 330 by performing a dot product operation using the two-dimensional input matrix 310 and the transposed columns WO0 through WOM of the two-dimensional weight matrix 320. For example, the VPU 270 loads the first row IB0 of the two-dimensional input matrix 310 to the input collector A 272. The VPU 270 may load the weight values of the transposed column WO0 to the input collector B 274. The VPU 270 determines a dot product value (e.g., by performing a dot product operation) using the first element IB0-0 and the weight values of the transposed column WO0.

For example, the VPU 270 calculates a product value between a first element IB0-0 and a first weight value of the transposed column WO0. The VPU 270 stores the product value in the accumulator 295. The VPU 270 calculates a product value between the first element IB0-0 and a second weight value of the transposed column WO0. The VPU 270 calculates a sum between the product value and the value stored in the accumulator 295. The VPU 270 stores the sum in the accumulator 295. The VPU 270 continues (e.g., using the first element IB0-0 and each of the weight values of the transposed column WO0) and stores a value corresponding to the dot product of the first element IB0-0 and the weight values of the transposed column WO0 in the accumulator 295.

The VPU 270 may then calculate a product value between a second element IB0-1 of the two-dimensional input matrix 310 and the first weight value of the transposed column WO0. The VPU 270 calculates a sum between the product value and the dot product value stored in the accumulator 295 (e.g., the dot product value resulting from the dot product operation performed using the first element IB0-0 and the weight values of the transposed column WO0). The VPU 270 continues to for all elements through element IB0-N of the first row IB0 of the two-dimensional input matrix 310. The VPU 270 stores a dot product value calculated for the element IB0-N and a last element of the transposed column WO0 as a first element OB0-0 of row OB0 of the two-dimensional output matrix 330.

The VPU 270 loads the transposed column WO1 to the input collector B 274. The VPU 270 calculates a dot product value (e.g., performs a dot product operation) for the first row IB0 of the two-dimensional input matrix 310 and the transposed column WO1. The VPU 270 stores the dot product value as a second element OB0-1 of the two-dimensional output matrix 330. The VPU 270 continues to determine dot product values for the first row IB0 of the two-dimensional input matrix 310 and each of the transposed columns of the two-dimensional weight matrix 320 through column WOM. The VPU 270 stores respective dot product values in respective elements of the two-dimensional output matrix 330.

The VPU 270 may then load the second row IB1 of the two-dimensional input matrix 310 to the input collector A 272 and the transposed column WO0 to the input collector B 274. The VPU 270 calculates a dot product value, as described, for the second row IB1 and the transposed column WO0. The VPU 270 stores the dot product value in a second row of the two-dimensional output matrix 330. The VPU 270 continues for all rows of the two-dimensional input matrix 310 and all transposed columns WO0 through WOM of the two-dimensional weight matrix 320. In some embodiments, the VPU 270 may calculate the dot product values for the rows of the two-dimensional input matrix 310 and transposed columns of the two-dimensional weight matrix 320 in parallel. The number of dot product values calculated by the VPU 270 in parallel may vary based on a size of the input batches, as described, and/or a number of registers in the VPU 270. In some embodiments, the VPU 270 may prefetch subsequent transposed columns of the two-dimensional weight matrix 320 while performing dot product operations using a current transposed column of the two-dimensional weight matrix 320.

In some embodiments, the registers used for storing the transposed columns of the two-dimensional weight matrix 320 are of size N (e.g., each register can hold N weight values). Accordingly, when the rows of the two-dimensional weight matrix 320 is not divisible by N, the two-dimensional weight matrix 320 may include remainder rows. In some embodiments, the VPU 270 does not transpose the portions of the columns of the two-dimensional weight matrix 320 associated with the remainder rows. The VPU 270 proceeds as described with respect to performing a dot product operation using a two-dimensional input matrix arranged in row-major order and a two-dimensional weight matrix arranged in column-major order, for the remainder rows. The VPU 270 may continue, as described, to transpose other portions of the columns of the two-dimensional weight matrix 320, and proceed as described.

In some embodiments, the VPU 270 may include multiple memory and/or register architectures. The VPU 270 may select a largest register size of all available memory and/or register architectures and identify portions of the columns of the two-dimensional weight matrix 320 corresponding to the size of the selected register size.

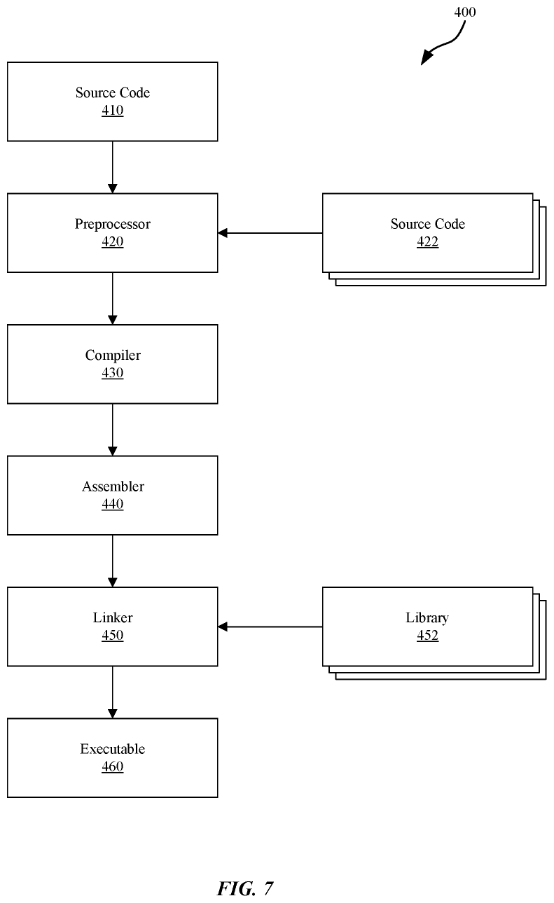

FIG. 7 illustrates a workflow 400 for compiling source code into an executable program, in accordance with some embodiments. As shown in FIG. 7, a software developer generates source code 410 for an application. The source code 410 can be written in a variety of programming languages. The first step in compiling the source code 410 is performed by a program called a preprocessor 420. The preprocessor 420 parses the source code 410 and expands preprocessor directives such as macros, conditional compiler statements, and include statements. In some cases, the preprocessor 420 can replace a preprocessor directive included in the source code 410 with additional source code 422 in one or more separate files.

The pre-processed source code is then processed by the compiler 430, which converts the source code from a high-level language to an assembly language. The converted source code is then processed by the assembler 440, which converts the source code from the assembly language to machine code, which can be referred to as an object file. Finally, the object file is processed by the linker 450, which links the object file with libraries 452 (e.g., additional pre-compiled object files) to produce an executable program 460.

It will be appreciated that the techniques described above for performing a matrix multiplication operation can be implemented in multiple ways. For example, referring to various parts of FIG. 7, the source code 410 can include high-level program code that, when compiled into the executable program 460 and executed by the vector processor 200, causes the vector processor 200 to transpose the columns of the two-dimensional weight matrix 320 and generate the two-dimensional output matrix 330, as described.

In some embodiments, the high-level program code can be generated by a first software developer and provided to a second software developer as a software framework within one or more of the additional source code 422 files. The second software developer can then utilize the functions included in the software framework to include similar functionality related to performing matrix multiplication operations as described in more detail above. For example, the software framework could provide constructors and methods for implementing a matrix multiplication operating for a fully-connected layer having a two-dimensional weight matrix arranged in column-major order.

In yet other embodiments, a software developer can develop libraries 452 that are compiled into object code and linked with the object code generated by the assembler 440 during compilation of the executable program 460. The software developer can specify an application programming interface (API) that is utilized within the source code 410 to call functions implemented by the libraries 452. For example, a library could be specified that transposes the columns of the two-dimensional weight matrix 320 and generates the two-dimensional output matrix 330, as described. Such embodiments are different from the software framework described above in that the libraries are compiled into binary object files, and source code for the functions in the libraries are typically not provided to the software developer to modify or extend.

In still other embodiments, such functionality can be built-in to an operating system that provides an execution environment for the executable program 460. For example, transposing the columns of the two-dimensional weight matrix 320 and generating the two-dimensional output matrix 330, as described, can be a standard operation made available to executable program 460 by the operating system by way of a system call.

FIG. 5 illustrates a flowchart of a method 500 for optimizing a matrix multiplication operation on a vector processor, in accordance with some embodiments. The method 500 can be performed by software, hardware, or any combination of software or hardware. In some embodiments, the method 500 is implemented by a plurality of instructions executed by the vector processor 200 included in a computing device.

At 502, a computing device including a vector processor receives a two-dimensional input matrix arranged in row-major order, such as the two-dimensional input matrix 310, as described. At 504, the computing device receives a two-dimensional weight matrix arranged in column-major order, such as the two-dimensional weight matrix 320, as described.

At 506, the computing device generates a two-dimensional output matrix, such as the two-dimensional output matrix 330, as described, using rows of the two-dimensional input matrix 310, and transposed columns of the two-dimensional weight matrix 320. For example, as described, the computing device transposes the columns of the two-dimensional weight matrix 320 and stores the weight values of each transposed column sequentially. The computing device determines a dot product value by broadcasting elements of a respective row of the two-dimensional input matrix 310 to each of the transposed columns of the two-dimensional weight matrix 320. The dot product value is stored in respective element of the two-dimensional output matrix 330. The computing device continues to determine dot product values for each respective row of the two-dimensional input matrix 310 using each transposed column of the two-dimensional weight matrix 320, as described. The computing device generates the two-dimensional output matrix 330 using the determined dot product values, as described.

FIG. 10 illustrates a detailed view of an exemplary computing device 600 that can be used to implement the various apparatus and/or methods described herein, in accordance with some embodiments. In particular, the detailed view illustrates various components that can be included in the computing devices described herein.

As shown in FIG. 10, the computing device 600 includes a processor 602 that represents a microprocessor or controller for controlling the overall operation of computing device 600. In some embodiments, the processor 602 is a vector processor 200. Alternatively, the processor 602 can communicate with the vector processor 200 to execute the transposition of the columns of the two-dimensional weight matrix 320. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 (screen display) that can be controlled by the processor 602 to present visual information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

In some embodiments, the processor 602 can be embodied in a variety of forms. For example, the processor 602 can be embodied as various processing hardware-based means such as a microprocessor, a coprocessor, a controller or various other computing or processing devices including integrated circuits such as, for example, an application specific integrated circuit (ASIC), a field programmable gate array (FPGA), some combination thereof, or the like. Although illustrated as a single processor, it will be appreciated that the processor 602 can include two or more processors. The processors can be in operative communication with each other and can be collectively configured to perform one or more functionalities of the computing device 600 as described herein. In some embodiments, the processor 602 can be configured to execute instructions that can be stored in the RAM 620 or that can be otherwise accessible to the processor 602.

The computing device 600 also include a storage device 640, which can comprise a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of the computing device 600.

In some embodiments, a method for establishing a fully-connected inference implementation using a convolutional neural network includes, at a computing device, receiving a two-dimensional input matrix that includes a plurality of elements. The method further includes identifying a two-dimensional weight matrix corresponding to the two-dimensional input matrix, the two-dimensional weight matrix including a plurality of weight values. The method further includes transposing a first column of the two-dimensional weight matrix to produce a transposed first column. The method further includes storing the transposed first column of the two-dimensional weight matrix in a first register having a first length corresponding to the transposed first column. The method further includes generating a first output element by performing a first dot product operation using a first row of the two-dimensional input matrix and the transposed first column. The method further includes storing the first output element in a first row of a two-dimensional output matrix.

In some embodiments, the two-dimensional weight matrix is arranged in column-major order. In some embodiments, the method is implemented by at least one processor included in the computing device, the at least one processor includes at least one vector processing unit. In some embodiments, the method further includes transposing a second column of the two-dimensional weight matrix to produce a transposed second column and storing the transposed second column of the two-dimensional weight matrix in a second register having a second length corresponding to the transposed second column. In some embodiments, the method further includes generating a second output element by performing a second dot product operation using the first row of the two-dimensional input matrix and the transposed second column and storing the second output element in the first row of the two-dimensional output matrix. In some embodiments, the method further includes generating a third output element by performing a third dot product operation using a second row of the two-dimensional input matrix and the transposed first column and storing the third output element in a second row of the two-dimensional output matrix. In some embodiments, weight values associated with the transposed first column are read sequentially.

In some embodiments, at least one non-transitory computer readable medium is configured to store instructions that, when executed by at least one processor included in a computing device, cause the computing device to perform steps that include: receiving a two-dimensional input matrix that includes a plurality of elements; identifying, by a processor, a two-dimensional weight matrix corresponding to the two-dimensional input matrix, the two-dimensional weight matrix including a plurality of weight values; transposing a first column of the two-dimensional weight matrix to produce a transposed first column; storing the transposed first column of the two-dimensional weight matrix in a first register having a first length corresponding to the transposed first column; generating a first output element by performing a first dot product operation using a first row of the two-dimensional input matrix and the transposed first column; and storing the first output element in a first row of a two-dimensional output matrix.

In some embodiments, the two-dimensional weight matrix is arranged in column-major order. In some embodiments, the at least one processor includes at least one vector processing unit. In some embodiments, the steps further include transposing a second column of the two-dimensional weight matrix to produce a transposed second column and storing the transposed second column of the two-dimensional weight matrix in second register having a second length corresponding to the transposed second column. In some embodiments, the steps further include generating a second output element by performing a second dot product operation using the first row of the two-dimensional input matrix and the transposed second column and storing the second output element in the first row of the two-dimensional output matrix. In some embodiments, the steps further include generating a third output element by performing a third dot product operation using a second row of the two-dimensional input matrix and the transposed first column and storing the third output element in a second row of the two-dimensional output matrix. In some embodiments, weight values associated with the transposed first column are read sequentially.

In some embodiments, a computing device configured to establish a fully-connected inference implementation using a convolutional neural network includes at least one memory and at least one vector processor. The at least one memory is configured to store: a two-dimensional input matrix that includes a plurality of elements; and a two-dimensional weight matrix corresponding to the two-dimensional input matrix, the two-dimensional weight matrix including a plurality of weight values. The at least one vector processor is coupled to the at least one memory and configured to cause the computing device to: transpose a first column of the two-dimensional weight matrix to produce a transposed first column; store the transposed first column of the two-dimensional weight matrix in a first register having a first length corresponding to the transposed first column; generate a first output element by performing a first dot product operation using a first row of the two-dimensional input matrix and the transposed first column; and store the first output element in a first row of a two-dimensional output matrix.

In some embodiments, the two-dimensional weight matrix is arranged in column-major order. In some embodiments, the at least one vector processor further causes the computing device to transpose a second column of the two-dimensional weight matrix to produce a transposed second column and store the transposed second column of the two-dimensional weight matrix in a second register having a second length corresponding to the transposed second column. In some embodiments, the vector processor further causes the computing device to generate a second output element by performing a second dot product operation using the first row of the two-dimensional input matrix and the transposed second column and store the second output element in the first row of the two-dimensional output matrix. In some embodiments, the vector processor further causes the computing device to generate a third output element by performing a third dot product operation using a second row of the two-dimensional input matrix and the transposed first column and store the third output element in a second row of the two-dimensional output matrix. In some embodiments, weight values associated with the transposed first column are read sequentially.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for establishing a fully-connected inference implementation using a convolutional neural network, the method comprising, at a computing device:
receiving a two-dimensional input matrix that includes a plurality of elements;
identifying, by a processor, a two-dimensional weight matrix corresponding to the two-dimensional input matrix, the two-dimensional weight matrix including a plurality of weight values;
transposing a first column of the two-dimensional weight matrix to produce a transposed first column;
storing the transposed first column of the two-dimensional weight matrix in a first register having a first length corresponding to the transposed first column;
generating a first output element by performing a first dot product operation using a first row of the two-dimensional input matrix and the transposed first column; and
storing the first output element in a first row of a two-dimensional output matrix.

2. The method of claim 1, wherein the two-dimensional weight matrix is arranged in column-major order.

3. The method of claim 1, wherein the method is implemented by at least one processor included in the computing device, and the at least one processor includes a vector processing unit.

4. The method of claim 1, further comprising:
transposing a second column of the two-dimensional weight matrix to produce a transposed second column; and
storing the transposed second column of the two-dimensional weight matrix in a second register having a second length corresponding to the transposed second column.

5. The method of claim 4, further comprising:
generating a second output element by performing a second dot product operation using the first row of the two-dimensional input matrix and the transposed second column; and
storing the second output element in the first row of the two-dimensional output matrix.

6. The method of claim 1, further comprising:
generating a third output element by performing a third dot product operation using a second row of the two-dimensional input matrix and the transposed first column; and
storing the third output element in a second row of the two-dimensional output matrix.

7. The method of claim 1, wherein weight values associated with the transposed first column are read sequentially.

8. At least one non-transitory computer readable medium storing instructions that, when executed by at least one processor included in a computing device, cause the computing device to perform steps that include:
receiving a two-dimensional input matrix that includes a plurality of elements;
identifying a two-dimensional weight matrix corresponding to the two-dimensional input matrix, the two-dimensional weight matrix including a plurality of weight values;
transposing a first column of the two-dimensional weight matrix to produce a transposed first column;
storing the transposed first column of the two-dimensional weight matrix in a first register having a first length corresponding to the transposed first column;
generating a first output element by performing a first dot product operation using a first row of the two-dimensional input matrix and the transposed first column; and
storing the first output element in a first row of a two-dimensional output matrix.

9. The at least one non-transitory computer readable medium of claim 8, wherein the two-dimensional weight matrix is arranged in column-major order.

10. The at least one non-transitory computer readable medium of claim 8, wherein the at least one processor includes at least one vector processing unit.

11. The at least one non-transitory computer readable medium of claim 8, wherein the steps further include:
transposing a second column of the two-dimensional weight matrix to produce a transposed second column; and
storing the transposed second column of the two-dimensional weight matrix in a second register having a second length corresponding to the transposed second column.

12. The at least one non-transitory computer readable medium of claim 11, wherein the steps further include:
generating a second output element by performing a second dot product operation using the first row of the two-dimensional input matrix and the transposed second column; and
storing the second output element in the first row of the two-dimensional output matrix.

13. The at least one non-transitory computer readable medium of claim 8, wherein the steps further include:
generating a third output element by performing a third dot product operation using a second row of the two-dimensional input matrix and the transposed first column; and
storing the third output element in a second row of the two-dimensional output matrix.

14. The at least one non-transitory computer readable medium of claim 8, wherein weight values associated with the transposed first column are read sequentially.

15. A computing device configured to establishing a fully-connected inference implementation using a convolutional neural network, the computing device comprising:
at least one memory storing:
a two-dimensional input matrix that includes a plurality of elements, and
a two-dimensional weight matrix corresponding to the two-dimensional input matrix, the two-dimensional weight matrix including a plurality of weight values, and
at least one vector processor coupled to the at least one memory and configured to cause the computing device to:
transpose a first column of the two-dimensional weight matrix to produce a transposed first column;
store the transposed first column of the two-dimensional weight matrix in first a register having a first length corresponding to the transposed first column;
generate a first output element by performing a first dot product operation using a first row of the two-dimensional input matrix and the transposed first column; and
store the first output element in a first row of a two-dimensional output matrix.

16. The computing device of claim 15, wherein the two-dimensional weight matrix is arranged in column-major order.

17. The computing device of claim 15, wherein the at least one vector processor further causes the computing device to:
transpose a second column of the two-dimensional weight matrix to produce a transposed second column; and
store the transposed second column of the two-dimensional weight matrix in a second register having a second length corresponding to the transposed second column.

18. The computing device of claim 17, wherein the at least one vector processor further causes the computing device to:
generate a second output element by performing a second dot product operation using the first row of the two-dimensional input matrix and the transposed second column; and
store the second output element in the first row of the two-dimensional output matrix.

19. The computing device of claim 15, wherein the at least one vector processor further causes the computing device to:
generate a third output element by performing a third dot product operation using a second row of the two-dimensional input matrix and the transposed first column; and
store the third output element in a second row of the two-dimensional output matrix.

20. The computing device of claim 15, wherein weight values associated with the transposed first column are read sequentially.
